(19) United States
(12) Patent Application Publication
(10) Pub. No.: US 2004/0098984 A1
(43) Pub. Date: May 27, 2004

(54) Combination hydraulic system and electronically controlled vehicle and method of operating same

(76) Inventors: Charles A. Duell, Crestline, OH (US); Richard T. Williams, Lewis Center, OH (US)

Correspondence Address: David M. Frischkorn, McDonnell Boehnen Hulbert & Berghoff, 32nd Floor, 300 S. Wacker Drive, Chicago, IL, 60606, US

(21) Appl. No.: 10/304,905

(22) Filed: Nov. 26, 2002

(51) Int. Cl. F16D 31/02

(52) U.S. Cl. 60/431

(57) ABSTRACT

A combination of an electronically controlled vehicle and a hydraulic system and method of operating same for monitoring and controlling the flow of hydraulic fluid in a hydraulic system having at least one hydraulic actuator is provided. An electronic control system (ECS) processes system parameters and information and allocates engine power and controls pump output while maintaining optimum engine performance. The combination of an electronically controlled vehicle and a hydraulic system prevents hydraulic overloads, avoids increased engine RPM, and reduces unnecessary wear and tear on system components while significantly reducing fuel consumption and the emissions of pollutants and noise during operation.

### BACKGROUND OF THE INVENTION

1. Field of Invention

This invention relates to a unique combination of an electronically controlled vehicle and an efficient hydraulic system to operate at least one hydraulic actuator. More specifically our invention is directed to an improved hydraulic system for operating hydraulic actuators, such as a hydraulic cylinder, whereby the electronic control system (ECS) of an electronically controlled vehicle works in conjunction with a load sense circuit and a control valve to manage and allocate engine power and control hydraulic fluid pressure and flow in the hydraulic system.

1 Discussion of the Prior Art

Vehicles and equipment that use hydraulic actuators, in particular, linear and rotary hydraulic actuators, such as hydraulic cylinders and motors, are clearly known. To operate these hydraulic actuators, hydraulic systems must be available that have at a minimum an operator control that signals which actuator is to be operated, a pump to pressurize and cause hydraulic fluid to flow to the work port of the actuator, a control valve to redistribute pressurized hydraulic fluid to the actuators that are to be activated and a source of power to drive the pump. One type of hydraulic system is disclosed in U.S. Pat. No. 6,312,209. Typically, the power source to drive the hydraulic pump is an internal combustion engine, either gasoline or diesel operated, however, other engine types can be used, including electric motors and alternative fueled prime movers. The engine is also used to power other applications besides the hydraulic system. For example, in vehicle applications, the engine provides the power for the drive train, fuel pump, cooling pump, electrical generator, air compressor and other accessories. Managing the power output of the engine is extremely important to obtain good fuel efficiency, optimum engine performance and to minimize wear and tear on mechanical components. The art has recognized this need and has developed electronically controlled vehicles that have one or more computer based electronic control units that comprise an electronic controlled system (ECS), which monitor various vehicle system parameters such as vehicle speed, engine RPM, engine oil temperatures and pressure, air temperature, fuel pressure and coolant levels and makes adjustments to electronic fuel injection to balance the power requirements. What the art has not recognized is the need to also monitor process and control information relating to hydraulic systems that are required to operate various types of hydraulic actuators so that the ECS can change the allocation of available engine power in a fuel-efficient and safe manner. Our invention provides both a method and a system to accomplish this goal.

Accordingly, one objective of our invention is to provide a combination of an electronically controlled vehicle and hydraulic system that efficiently operates at least one hydraulic actuator where the vehicle contains computer controlled units that control the overall function of the vehicle, the engine, the braking system, the transmission and other vehicle systems.

Another object is to provide a method of operating at least one hydraulic actuator using an operator control, an electronically controlled vehicle, a control valve and a pump, whereby the ECS is programmed to manage and efficiently change the allocation of power to an engine and to control a hydraulic system. Yet another object of our invention is to provide a system and method of operating the system on a vehicle containing at least one hydraulic actuator, whereby an ECS, in electronic communication with both an engine and a variable volume piston pump monitors and allocates power output of the engine and controls the operation of the pump during operation of the hydraulic actuator based on a priority logic software program.

Other objects will be recognized upon reading the following disclosure in conjunction with the accompanying figure.

### SUMMARY OF THE INVENTION

Our invention relates to a method and system for managing engine power allocation and controlling the flow of hydraulic fluid in a hydraulic system during the operation of at least one hydraulic actuator, specifically a rotary or linear actuator or a combination thereof. Types of hydraulic actuators that can be used in our invention include for example, cylinders, motors, or any combination of actuators. To accomplish the goal of our invention most efficiently, we have designed a system that for the first time allows an electronically controlled vehicle to bi-directionally communicate with a hydraulic system capable of operating at least one hydraulic actuator. By “bidirectionally” we mean that signals are sent to and from the ECS and the hydraulic system during operation of the vehicle. The most typical application for our invention would be on a vehicle, such as a refuse truck, fire truck, or other utility vehicle, however, our invention could also be used on moving or stationary equipment, such as, cranes, tractors, elevators, earth movers, snow removal equipment, and other heavy duty equipment. Critical to our invention is the bi-directional communication and control that exists between the electronic vehicle's computer control system (ECS), which comprises one or more computer based control units well known to those skilled in the art, and the hydraulic system, whereby the ECS constantly monitors the resistance or load placed on the hydraulic actuators and changes the allocation of engine power by manipulating engine horsepower, the pump stroke limit or a combination of both. Prior art vehicles and equipment had either no controls or relied solely on the fluid communication between an operator control and a control valve to control hydraulic fluid flow to the work port(s) of the hydraulic actuator(s). These prior art systems relied on throttle control either by an operator or by using a predetermined point because there was no communication between the hydraulic pump and any electronic control unit on the vehicle that comprises the ECS. Moreover, these prior art systems are inefficient in that pumps are overworked and they oversupply hydraulic fluid to the hydraulic system. In other words, the output of the pump exceeds the hydraulic system demand required to overcome the load on the hydraulic actuator. The hydraulic demand is that necessary for the hydraulic actuator to bear the external load placed on the hydraulic actuator. Further, these prior art systems operate at high engine RPM, have poor fuel efficiency, generate significant noise and air pollution, and cause excessive wear and tear on moving parts.

Our invention overcomes the problems found in prior art systems by using a load sense circuit that is in fluid communication with a control valve and which continuously monitors the resistance or load placed on one or more hydraulic actuators. The load sense circuit continuously supplies a fluid signal to a signal converter or pressure transducer, which in turn sends an electrical signal indicating resistance information to the ECS of an electronically controlled vehicle. The ECS comprises one or more computer controlled processor units. The ECS is electrically connected to not just the engine, but also to a hydraulic pump controller. This allows the ECS to monitor the hydraulic system power requirements. Information such as engine speed (RPM), vehicle speed, fuel consumption and engine oil pressure and other vehicle operating parameters are likewise constantly supplied to and monitored by the ECS. The ECS and its various electronic control units are programmed through appropriate software to process all these inputs, as well as the information received from the hydraulic system, and uses a predetermined and programmed priority logic system to determine the power allocation that is the most efficient to operate the vehicle and hydraulic system under any particular set of conditions. The priority logic system of our invention, when used on a vehicle, will change the allocation of engine power according to a predetermined, prioritized scheme whereby the first priority is vehicle propulsion. In other words, if the ECS determines that the vehicle is in motion and/or accelerating it will divert power from the hydraulic system in order to maintain these requirements and the operator's driving commands, such as acceleration, turning, etc. Operation of other systems, such as the hydraulic system, are secondary priorities, unless the vehicle is at rest, then the hydraulic system could be a first priority. If the vehicle is stationary and the engine is at idle, the ECS will change the allocation of engine power to prevent the engine from exceeding a predetermined engine droop. In one possible situation, where a variable volume pump is used in combination with a single hydraulic actuator, the ECS will monitor the hydraulic system requirements and continuously determines and sets a piston stroke limit. The piston stroke limit is a determination of how much volumetric output of hydraulic fluid will be delivered by the variable volume pump through changes in the pump piston stroke. This piston stroke limit will be communicated to the pump controller as a signal, where the pump controller interprets the piston stroke limit signal from the ECS and adjusts the stroke of the variable volume pump accordingly to meet the demand set by the ECS. In some instances the pump controller can also receive load sense signals via a fluid communication directly from the control valve. In such a situation, the pump stroke limit set by the ECS will be the controlling variable as to whether the pump controller will allow the piston stroke to change to supply the volume of hydraulic fluid needed to fulfill the demand determined by the load sense circuit. When resistance on the hydraulic actuator is increasing, the pump controller uses the input from the ECS to control the hydraulic fluid volumetric output of the pump by increasing the pump stroke, thus increasing the volumetric output of the pump. Likewise, when the resistance on the one single hydraulic actuator is decreasing, the pump controller will decrease the pump stroke, thus decreasing the hydraulic fluid volumetric output. Of course, in situations where there are multiple hydraulic actuators operating independently of each other and handling varying work loads, the ECS may actually increase the pump stroke limit, thus causing an increase in volumetric pump output even though the load on one hydraulic actuator is decreasing. Such a situation could occur when the load on one hydraulic actuator is decreasing while the load on another hydraulic actuator is increasing. An important feature of our invention is that the load sense circuit of our invention continuously provides load information to the ECS, which in turn continuously determines and sets a piston stoke limit that ultimately determines the maximum volumetric output of hydraulic fluid available from the pump.

In systems using a fixed volume pump, such as a gear pump, there is no need for a piston stroke limit because the pump is fixed volume. In this situation, the ECS can increase or decrease engine speed to vary the volumetric output of the pump. When a fixed volume pump is used, such as a gear or vane pump, or a combination of these pumps, or a multi-section fixed volume pump, the ECS will monitor engine RPM and when the RPM reaches certain predetermined speeds, the ECS will send a signal to a solenoid valve(s) that will open or close diverter valves to maintain a relative constant volumetric output to the control valve.

Both variable and fixed volume pumps will work in our invention and the specific design of the particular type of pump chosen is not critical to our invention, however, a preferred type of pump is a variable volume piston pump that can operate at a constant speed and vary its volumetric output by changing the piston stroke. The variable volume piston pump is capable of varying the displacement of the pump per revolution from zero to maximum through built-in mechanical means. The pump output is based on the feedback (load sense signal) received from the load sense circuit, which may be located within the control valve. In operation, the variable volume pump strives to maintain a constant pressure differential by varying the pump's piston stroke, thus varying the rate of hydraulic fluid flow. The pressure differential between the load-sense signal pressure and the pump output pressure is referred to as the margin pressure. Stand-by pressure is the pump output pressure when used in connection with a closed center control valve in the neutral position, i.e., no load-sense signal exists. Because the controller on the pump controls the fluid flow to the valve, a main relief valve is not required. Likewise, when the load or resistance on the hydraulic actuator is increased, there is no need to increase the RPM of the engine driving the pump because the pump adjusts the piston stroke and not the speed of the pump. No increase in engine RPM means no increase in the noise level during hydraulic system operation. This of course would reduce the so-called “annoyance factor” as the vehicle or equipment operates the hydraulic actuators. Energy conservation is also achieved because the pump flow is reduced to near zero when no load-sense exists and thus very little engine horsepower is needed. Likewise, because the engine does not need to increase RPM as the actuators are operated, fuel is conserved and this in turn significantly reduces emissions of pollutants into the environment.

The exact location of the load sense circuit on the vehicle or equipment is not important, as long as it accurately monitors the load placed on the hydraulic actuators. A preferred design has the load sense circuit integral to the control valve and comprising a series of induced load checks that are in fluid communication with the control valve and the work port(s) of the hydraulic actuators. The control valve of our invention can be of any design so long as it is capable of receiving a signal from an operator control and redirecting pressurized hydraulic fluid to the hydraulic actuator(s) that the operator desires to be operated. A preferred control valve is a closed center control valve with pressure compensated flow control. This type of valve accomplishes these above-described goals by providing just enough hydraulic fluid flow and pressure applied to the hydraulic actuators to perform the work/load required. A unique feature of the closed center control valve, as compared to the traditionally used open center valve, is the ability to block all pump fluid flow through the valve when the spool is in the neutral position. In comparison, the commonly used open center valve allows full pump flow to travel from the pump, typically a gear or vane pump, through the valve to the hydraulic fluid reservoir. Because we prefer to use the closed center valve in conjunction with a variable volume piston pump, as opposed to a fixed volume pump, the pump flow can be reduced to near zero when all spools are in neutral. When the spool is activated in response to activation of the operator control, the pump begins to stroke (thus producing hydraulic fluid flow) in order to maintain a set differential hydraulic fluid pressure.

To achieve maximum performance of the engine and hydraulic system of our invention it is preferred that the load sense circuit be able to sense the load being applied to the hydraulic actuator(s) and to communicate that load-sense to the pump controller. Working in conjunction with the signals received from the ECS, the pump controller causes the pump to either increase or decrease the hydraulic fluid flow in the system by varying the piston stroke. With the ability to sense the maximum load or resistance applied to the various hydraulic actuators, precise control of fluid flow is possible when there are multiple actuator demands working off one pump. This is in contrast to prior art systems that typically need more than one fixed volume pump operating in tandem. When less volume is needed, one or more pumps are shut down or its flow is diverted to meet the decreased requirement of the system. Another feature of the closed center valve is its ability to provide only the amount of hydraulic fluid flow and pressure to the work port of the actuator that is required. The amount of fluid flow delivered is proportional to the percent of valve spool stroke. The control valve is made up of sections and each section contains a pressure compensated flow control featuring a self adjusting variable orifice that maintains a constant flow rate of hydraulic fluid through the particular valve section under changing load conditions at a constant spool conditions. A preferred closed center valve is one of the PC series of valves, which is manufactured and sold by Parker Hannifin Corporation, Mobile Hydraulics Division.

### BRIEF DESCRIPTION OF THE DRAWING

The novel features of the invention are set forth in the claims. Preferred embodiments of the various forms of our inventions, however, together with further objects and attendant advantages, will be best understood by reference to the following description taken in connection with the accompanying drawing in which:

FIG. 1 is a schematic representation of the combination of an electronically controlled vehicle and a hydraulic system of our invention.

### DESCRIPTION OF PREFERRED EMBODIMENTS

To activate the hydraulic system of our invention and to perform the method of our invention, at least one operator control is required. In systems where multiple hydraulic actuators are present, our invention could typically require more than one operator control. Any type of operator control can be used, including manual and/or semi-automatic operator controls, and can operate using electrical, mechanical or fluid activation of the valve spools. For example, the operator control may be an electrical switch that triggers the operation of a hydraulic activator by causing a change in the position of a valve spool. Regardless of the particular design of the operator control, it is necessary to be in communication with a control valve such that pressurized hydraulic fluid is redirected to a work port of the hydraulic actuator. Although the specific design of the operator control is not critical to our invention, a preferred design is one that is commonly known as a pressurized air valve set up to act as a “dead man's switch.” Such a design requires the vehicle operator to apply a constant force on the control to activate its function. When our hydraulic system is used on a vehicle, the operator control is normally located in the cab portion of the vehicle, however, other operator controls may be located elsewhere on the vehicle. It is also preferred that the operator control can be moved in a number of directions, and will typically be designed to resemble a “joy stick.” As mentioned, the operator control is in communication with the control valve and specifically is connected to a mechanical actuator that is capable of moving a spool within the valve. The control valve and its internal spools are ultimately responsible for directing pressurized hydraulic fluid to various points within the system, including one or more hydraulic actuators. The hydraulic actuators that can be used in our invention include linear and/or rotary actuators, including, single stage and multi-stage hydraulic cylinders, hydraulic motors and the like.

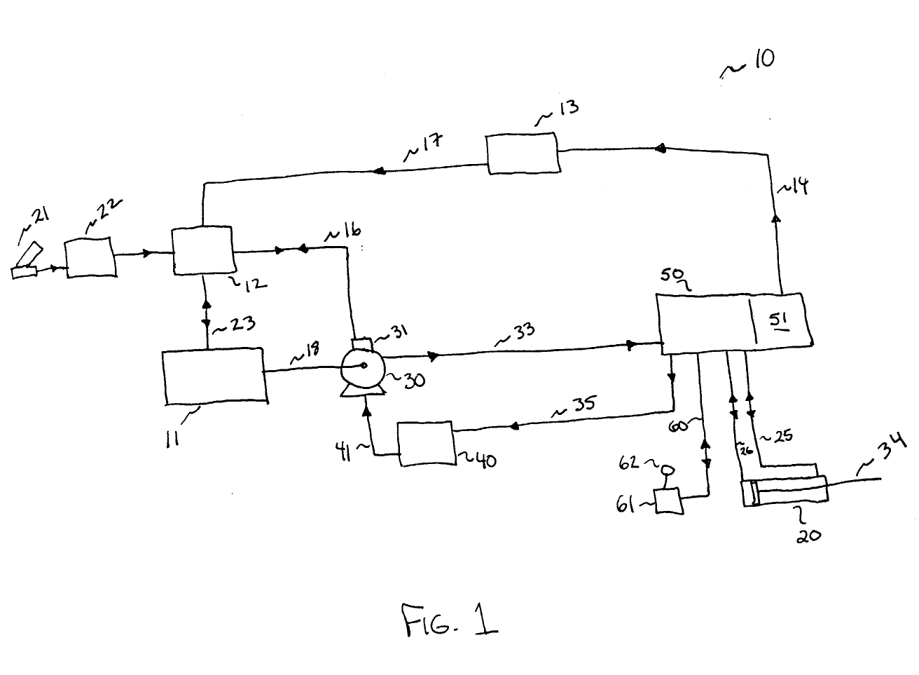

Reference to FIG. 1 illustrates a general schematic of our invention showing a combination of an electronically controlled vehicle and a hydraulic system operating at least one hydraulic actuator 10. FIG. 1 illustrates only a preferred construction. Clearly, other flow schemes or additional hardware may be constructed that utilize the elements of our invention. In fact, although the following descriptions may repeatedly refer to a vehicle having an engine, our invention is equally applicable to all types of vehicles and equipment that operate, manipulate, or otherwise utilize one or more hydraulic actuators provided there is means to drive the pump described herein. For simplicity, FIG. 1 omits various pressure relief valves, filters, bypass lines and other details that are not critical to our invention.

More specifically, FIG. 1 shows one embodiment of how the operator control 61 is in communication with a closed center control valve 50 through line 60. Joystick 62 is part of operator control 61 and is designed to cause the hydraulic actuator, shown in FIG. 1, as a hydraulic cylinder, to either extend or retract. When joystick 62 is moved in one direction a pressurized fluid, for example air, supplied from line 60 is directed to control valve 50 into a mechanical actuator that moves the specific valve spool within the control valve that is dedicated to the particular hydraulic actuator being controlled by the operator control. The mechanical actuator causes the valve spool to move in or out depending on whether the operator wants to extend or retract the cylinder to which it is in fluid connection. Depending on how the valve spool is positioned by the mechanical actuator after manipulation of the operator control 61, pressurized hydraulic fluid will flow through control valve 50 causing pressurized hydraulic fluid to either retract or extend the cylinder.

In FIG. 1 an engine 11 is mechanically connected to pump 30. The engine can be of any design, including those powered by diesel, gasoline compressed natural gas (CNG), liquefied natural gas, fuel cell, electricity, so long as it is electrically connected 23 to a software driven electronic control system (ECS) 12. In the situation where our invention is used on a vehicle, throttle pedal 21 is mechanically connected to throttle control 22, which in turn is electrically connected to ECS 12. When the operator of the vehicle desires to increase or decrease the speed of the vehicle he/she depresses or releases throttle pedal 21. This communicates an analog mechanical signal to throttle control 22 that transmits the analog mechanical signal to the ECS, which then converts it to a digital signal supplied to the ECS 12. The software in the ECS then sends an electrical signal to engine 11 via connection 23 to increase or decrease engine power, depending on the analog signal received from the vehicle operator. Engine 11 is also connected to the vehicle drive train (not shown) as well as other equipment (not shown), all of which require power for operation. As mentioned, the ECS determines the appropriate allocation of engine power.

In order to operate a hydraulic actuator, such as cylinder 20 shown in embodiment 10 of FIG. 1, the vehicle operator manipulates joystick 62. This sends a signal, typically via compressed fluid, to control valve 50 causing a mechanical actuator (not shown) to reposition the internal valve spool to direct pressurized hydraulic fluid from pump 30 to the working port of cylinder 20, either line 25 or 26, depending on whether the operator wants to retract or extend cylinder piston 34. Alternatively, the internal valve spool in control valve 50 is repositioned not by using a mechanical actuator, but instead by using electronic circuitry. Pump 30 pumps hydraulic fluid from tank 40 through line 41 and then through line 33 to control valve 50 and eventually to cylinder 20. In those embodiments of our invention where pump 30 is a variable volume piston pump, the volumetric output can be varied independent of the engine RPM. This means the flow of hydraulic fluid to the work port of a cylinder is independent of the engine RPM (and thus pump speed). Hydraulic fluid flows out of one side of cylinder 20, back through control valve 50 and via line 35 is eventually returned to tank 40. Load sense circuit 51 monitors the load on hydraulic cylinder 20. In systems where there are multiple hydraulic actuators in operation, the load sense circuit 51 monitors each of the hydraulic actuators and determines which work port requires the highest working hydraulic pressure needed to perform the requested work or load. In one embodiment, the load sense circuit sends a fluid signal indicating this highest working pressure to pressure transducer 13. In another embodiment the load sense circuit will send a signal to both the pump controller and the pressure transducer. Pressure transducer 13 converts the fluid signal to an electrical signal and communicates the information via line 17 to ECS 12. Pump controller 31 also communicates bi-directionally through electrical signals with ECS 12 via connection 16. The ECS, using installed software, processes the information received from pump controller 31 (hydraulic fluid system flow rates), load sense circuit 51 (required working pressure via pressure transducer 13), throttle control 22, other system components and engine 11 (vehicle speed, RPM, etc.) The ECS is programmed to continuously monitor and determine power availability and then will change the allocation of the available power to various vehicle systems while optimizing vehicle performance, i.e. maximum power at lowest possible fuel usage. The ECS will also constantly determine and set a piston stroke limit, which prevents the pump controller from increasing the variable volume pump stroke to exceed a volumetric output determined by the ECS. The ECS determines power allocation using the priority logic described above. If the ECS determines there is sufficient power to allocate to the hydraulic system, after taking into consideration the operator's driving commands, the vehicle speed, acceleration, etc., the ECS can send a signal via connection 23 to the engine to change engine power and/or speed. Likewise, the ECS can send a piston stroke limit signal via connection 16 to pump controller 31, which in turn controls the volumetric output of variable volume pump 30 by changing the pump stroke. In situations where a fixed volume pump is used in place of a variable volume pump and with an open center valve, the ECS can increase the speed of the engine, subject to the priority logic, thus increasing the speed of the pump and increasing pump output. Likewise, the ECS can reduce the engine RPM and thus reduce the volumetric output of the fixed volume pump. When a fixed volume pump is used with a closed center valve, then the ECS can control both the engine RPM and one or more diverter valves that operate to redirect the flow of hydraulic fluid away from the control valve.

The programming of the ECS to operate the various components of a vehicle is well known to those skilled in the art of vehicle and engine design. Although the exact software steps used are not critical to our invention, it is important to have software that carries out the priority logic described above. Likewise, the software causes the ECS to monitor the pressure of the hydraulic actuators via 17 and provide signal input to the pump via 16 and/or engine via 23 so that the required hydraulic fluid pressure and volume are made available to the hydraulic actuators, again subject to the priority logic. It would be routine for one skilled in the art to create the needed additional software programming for the ECS, once it is known what systems are to be monitored, what equipment needs controlling, and the priority logic as we have set forth herein..

Use of the hydraulic system of the present invention results in numerous advantages, many of which are mentioned above. It will be understood that the invention may be embodied in other specific forms without departing from its spirit or central characteristics. The present examples and embodiments, therefore, are to be considered in all respects as illustrative and not restrictive, and the invention is not to be limited to the details given here.

We claim:

1. A combination of an electronically controlled vehicle and a hydraulic system comprising, in combination,
a) a operator control having at least a first and second position;
b) at least one control valve having multiple ports in communication with the operator control such that movement of the operator control causes the control valve to change port positions redistributing flow of pressurized hydraulic fluid;
c) a hydraulic pump indirectly controlled by an electronic control system (ECS), where the pump is in fluid communication with the control valve and mechanically connected to an engine; and
d) a pressure transducer electrically connected to the ECS and also in fluid communication with at least one load sense circuit, where the load sense circuit is in fluid communication with at least one hydraulic actuator and is capable of sensing a load applied to the hydraulic actuator;

2. The system of claim 1 wherein the hydraulic actuator is a hydraulic cylinder.

3. The system of claim 1 wherein the load sense circuit is integral to at least one control valve.

4. The system of claim 1 wherein the load sense circuit is in fluid communication with at least one control valve.

5. The system of claim 1 wherein the hydraulic actuator is a hydraulic motor.

6. A method of operating a combined electronically controlled vehicle and hydraulic system comprising, in combination,
a) activating an operator control in communication with at least one control valve to effect movement of at least one hydraulic actuator;
b) directing pressurized hydraulic fluid using the control valve to the hydraulic actuator;
c) monitoring a resistance applied to the hydraulic actuator, hydraulic system fluid pressure, and volume using an electronic control system (ECS) electrically connected to an engine and to a pump controller, where the engine is mechanically connected to a hydraulic fluid pump having at least one piston;
d) converting a fluid signal received from at least one load sense circuit that is in communication with a pressure transducer to an electrical signal, whereby the load sense circuit is capable of sensing a resistance applied to the hydraulic actuator;
e) processing information received from the load sense circuit and hydraulic system volume information in the ECS and setting a pump stroke limit to control the hydraulic pump volumetric flow;
f) increasing or decreasing engine power output in response to the resistance placed on the hydraulic actuator; and
g) controlling the engine power and hydraulic pump output to prevent the engine power and pump output from exceeding that required to overcome the resistance applied to the hydraulic actuator.

7. The method of claim 6 where the vehicle is in a neutral transmission mode during the movement of the hydraulic actuator.

8. The method of claim 6 where the ECS controls hydraulic fluid pump output by increasing or decreasing engine power;

9. The method of claim 6 where the ECS controls hydraulic fluid pump output by changing the piston stroke limit;

10. The method of claim 6 where the ECS controls hydraulic fluid pump output by increasing or decreasing engine power, changing the pump stroke limit or a combination of both;

11. The method of claim 6 where hydraulic fluid pump output is monitored and controlled to prevent exceeding demand needed to overcome load on the hydraulic actuator.

12. A method of operating a combined electronically controlled vehicle and hydraulic system comprising, in combination,
a) activating an operator control in communication with at least one control valve to effect movement of at least one hydraulic actuator;
b) directing pressurized hydraulic fluid using the control valve to the hydraulic actuator as a result of a signal received by a pump controller connected to a hydraulic pump having at least one piston;
c) increasing or decreasing engine RPM in response to a load placed on the hydraulic actuator;
d) converting a fluid signal from at least one load sense circuit that is in communication with a pressure transducer to an electrical signal, where the load sense circuit is capable of sensing a load applied to the hydraulic actuator and;
e) processing the signal from the pressure transducer using an electronic control system (ECS) that is capable of receiving hydraulic fluid pressure and volume information and that is electrically connected to an engine that is mechanically connected to the hydraulic fluid pump; and
f) controlling engine power using the ECS to prevent engine power from exceeding that required to overcome the resistance applied to the hydraulic actuator.

13. The method of claim 12 where the vehicle is in a neutral transmission mode during the movement of the hydraulic actuator.

14. The method of claim 12 where the ECS controls hydraulic fluid pump output by increasing or decreasing engine power;

15. The method of claim 12 where the ECS sets a pump piston stroke limit;

16. The method of claim 15 where the ECS controls hydraulic fluid pump output by increasing or decreasing engine power, changing the pump piston stroke limit or a combination of both.

17. The method of claim 12 where hydraulic pump output is monitored and controlled to prevent exceeding demand needed to overcome the load on the hydraulic actuator.

18. A method of operating a combined electronically controlled vehicle and hydraulic system comprising, in combination,
a) activating an operator control in communication with at least one control valve to effect movement of at least one hydraulic actuator;
b) directing pressurized hydraulic fluid using the control valve to the hydraulic actuator as a result of a signal received by a pump controller connected to a hydraulic pump having at least one piston;
c) increasing or decreasing engine RPM in response to a load placed on the hydraulic actuator;
d) converting a fluid signal from at least one load sense circuit that is in communication with a pressure transducer to an electrical signal, where the load sense circuit is capable of sensing a load applied to the hydraulic actuator;
e) processing the signal from the pressure transducer using an electronic control system (ECS) that is capable of receiving hydraulic fluid pressure and volume information and that is electrically connected to an engine that is mechanically connected to the hydraulic fluid pump; and
f) sending a piston stroke limit signal from the ECS to the pump controller to either allow an increase or to decrease the volumetric output of the pump.

19. A method of operating a combined electronically controlled vehicle and hydraulic system comprising, in combination,
a) activating an operator control in communication with at least one control valve to effect movement of at least one hydraulic actuator;
b) directing pressurized hydraulic fluid using the control valve to the hydraulic actuator as a result of a signal received from the operator control;
c) converting a fluid signal from at least one load sense circuit that is in communication with a pressure transducer to an electrical signal and which is capable of sensing a load applied to the hydraulic actuator;
d) processing the signal from the pressure transducer using an electronic control system (ECS) that is electrically connected to an engine that is mechanically connected to the hydraulic fluid pump; and
e) sending a signal from the ECS to at least one diverter valve in fluid communication with the pump to either increase or decrease the volumetric output of the pump to the control valve.

20. A method of operating a combined electronically controlled vehicle and hydraulic system comprising, in combination,
a) activating an operator control in communication with at least one control valve to effect movement of at least one hydraulic actuator;
b) directing pressurized hydraulic fluid using the control valve to the hydraulic actuator as a result of a signal received from the operator control;
c) increasing or decreasing engine RPM in response to a load placed on the hydraulic actuator;
d) converting a fluid signal from at least one load sense circuit that is in communication with a pressure transducer to an electrical signal, where the load sense circuit is capable of sensing a load applied to the hydraulic actuator and;
e) processing the signal from the pressure transducer using an electronic control system (ECS) that is capable of receiving hydraulic fluid pressure and volume information and that is electrically connected to an engine that is mechanically connected to the hydraulic fluid pump; and
f) controlling engine power using the ECS to prevent engine power from exceeding that required to overcome the resistance applied to the hydraulic actuator.

21. A combination electronically controlled vehicle and hydraulic system for use on a refuse vehicle comprising, in combination,
a) a operator control located on a refuse vehicle having at least a first and second position;
b) at least one control valve having multiple ports in communication with the operator control such that movement of the operator control causes the control valve to change port positions redistributing flow of pressurized hydraulic fluid;
c) a hydraulic pump in fluid communication with the control valve and mechanically connected to an engine controlled by an electronic control system (ECS); and
d) a pressure transducer electrically connected to the ECS and also in fluid communication with at least one load sense circuit, where the load sense circuit is in fluid communication with at least one hydraulic cylinder and is capable of sensing a load applied to the hydraulic cylinder.

22. The system of claim 1 wherein the operator control comprises a joy stick in fluid communication with the control valve.

23. The system of claim 1 wherein the operator control comprises electronic circuitry capable of repositioning valve spools in the control valve.
